(19) United States
(12) Patent Application Publication
(10) Pub. No.: US 2025/0024562 A1
(43) Pub. Date: Jan. 16, 2025

(54) VEHICLE WINDOW GLASS WITH ELECTRICAL CONNECTOR SOLDERED BY LEAD-FREE SOLDER

(71) Applicant: ACR II GLASS AMERICA INC., Nashville, TN (US)

(72) Inventor: Olivier Farreyrol, Grevenmacher (LU)

(21) Appl. No.: 18/899,822

(22) Filed: Sep. 27, 2024

Related U.S. Application Data
(63) Continuation of application No. 18/136,510, filed on Apr. 19, 2023, now Pat. No. 12,144,071.
Application No. 18/136,510 is a continuation of application No. 15/926,502, filed on Mar. 20, 2018, now Pat. No. 11,659,631.

(30) Foreign Application Priority Data
Mar. 22, 2017 (GB) 1704525.3

(51) Int. Cl. H05B 3/86; C03C 27/04; C22C 38/08; C22C 38/10; H01R 4/02; H01R 43/02; H05B 3/06; H05B 3/84

(52) U.S. Cl. CPC H05B 3/86; C03C 27/046; C22C 38/08; C22C 38/105; H01R 4/02; H05B 3/06; H05B 3/84; H01R 43/0214; H01R 2201/26; H05B 2203/016

(57) ABSTRACT

A vehicle window glass comprises a glass substrate layer, an electrically conductive layer forming a conductive pattern over the glass substrate, a lead-free solder layer on the conductive layer and a metal plate element of an electrical connector on the solder layer. Optionally a colored ceramic band layer is sintered between the glass substrate layer and the conductive layer. The thickness of the metal plate element is between 0.5 mm and 0.7 mm.5

### CROSS-REFERENCE TO RELATED APPLICATIONS

This application is a continuation of U.S. patent application Ser. No. 18/136,510, filed on Apr. 19, 2023, which is a continuation of U.S. patent application Ser. No. 15/926,502, filed Mar. 20, 2018, which claims foreign priority benefits under 35 U.S.C. § 119 to Great Britain Patent Application No. GB 1704525.3, filed Mar. 22, 2017, the entire content of which is incorporated herein by reference.

### TECHNICAL FIELD

The invention relates to a vehicle window glass comprising an electrically conductive layer over the window glass, and an electrical connector soldered by a lead-free solder on the conductive layer.

### BACKGROUND OF THE INVENTION

In a vehicle window glass comprising an electrically conductive layer over the window glass and an electrical connectors soldered by a solder on the conductive layer, lead-containing solders have been used. However, the End of Life Vehicles Directive 2000/53/EC urges the use of lead-free solders instead of the lead-containing solders.

The use of lead-free solders has led to a difficulty in compensating mechanical stresses between the window glass and the electrical connectors, resulting in the occurrence of cracks in the window glass.

In order to solve this problem, U.S. Pat. No. 8,816,214 discloses a window glass comprising a glass substrate and an electrical connector made of a metal having thermal expansion coefficient near to that of the glass substrate.

WO2007/110610 suggests that a thinner electrical connector, preferably an electrical connector having 0.1 mm to 0.5 mm thickness, can reduce the mechanical stress.

US2016/0296569 proposes a discrete compensator plate between the connector and the conductive layer.

### SUMMARY OF THE INVENTION

The window glass disclosed in U.S. Pat. No. 8,816,214 is found to be still insufficient from the point of view of crack occurrences in the glass substrate. Thus, further improvement is required. Although WO2007/110610 suggests that an electrical connector having 0.1 mm to 0.5 mm thickness can reduce the mechanical stress, we found that such very thin electrical connectors are liable to the formation of hot spots in the connector during the soldering process using electric resistance heating of the connector. The generation of hot spots may result in residual stresses in the glass substrate, which cause cracks in the glass substrate.

It is an aim herein to provide new vehicle window glass comprising an electrically conductive layer over the window glass, and an electrical connector soldered by a lead-free solder on the conductive layer, especially taking account off the drawbacks mentioned above.

According to one aspect of the present invention, there is provided a vehicle window glass, comprising:
a glass substrate layer;
an electrically conductive layer forming a conductive pattern over the glass substrate;
a solder layer on the conductive layer; and a metal plate element;
wherein a thickness of the metal plate element is between 0.5 mm and 0.7 mm.

Other aspects and preferred aspects are set out in the claims and discussed below.

A colored ceramic band layer may be provided between the glass substrate layer and the conductive layer. This is usually a sintered layer.

The thickness of the solder layer may be between 0.1 mm and 0.3 mm. The solder layer may be made of a tin-based metal alloy comprising silver.

The metal plate element may be, or may be comprised in, an electrical connector for connecting the electrically conductive layer to external electric wiring. Such electrical connector may comprise first and second said metal plate elements connected by a bridge portion, preferably formed integrally from a single piece of metal plate material.

The thickness of the metal plate element is preferably at least 0.52 mm, more preferably at least 0.54 mm. The thickness is preferably not more than 0.65 mm, more preferably not more than 0.6 mm.

The metal plate element preferably comprises or consists of iron alloy such as Invar 48.

Preferably the surface of the metal plate element facing the solder layer is flat. The metal plate element may be coated with one or more metals selected from Ni, Cu and Ag, e.g., Ni, Cu and Ag layers in that order from the element.

Another aspect is a method of making such a window glass, comprising
preparing the glass substrate having the electrically conductive layer on the glass substrate, and optionally with said colored ceramic band layer between the glass substrate and the conductive layer;
preparing an electrical connector comprising said at least one metal plate element with a surface to be soldered;
placing lead-free solder on the conductive layer, and
heating the electrical connector, such as by electric resistance heating, to melt the lead-free solder between the conductive layer and said surface of the metal plate element.

### ADVANTAGEOUS EFFECT OF THE INVENTION

We find that by using a window glass having the above structure, the mechanical stress between the window glass and an electrical connector including the metal plate element can be relaxed, and crack occurrence is decreased.

### BRIEF DESCRIPTION OF THE DRAWINGS

FIG. 1 is a schematic view showing main components for the present invention, and FIG. 2 is a cross-sectional view at X-Y of FIG. 1.

### DETAILED DESCRIPTION

In the following description, for purposes of explanation and not limitation, specific details are set forth in order to provide an understanding of certain embodiments of the present invention. However, it will be apparent to those skilled in the art that the present invention may be practiced in other embodiments that depart from these specific details. In other instances, detailed descriptions of well-known devices, processes, techniques, and methods are omitted so as not to obscure the description with unnecessary detail.

We refer now more particularly to the accompanying drawings, in which like reference numerals indicate like parts/elements throughout the several views.

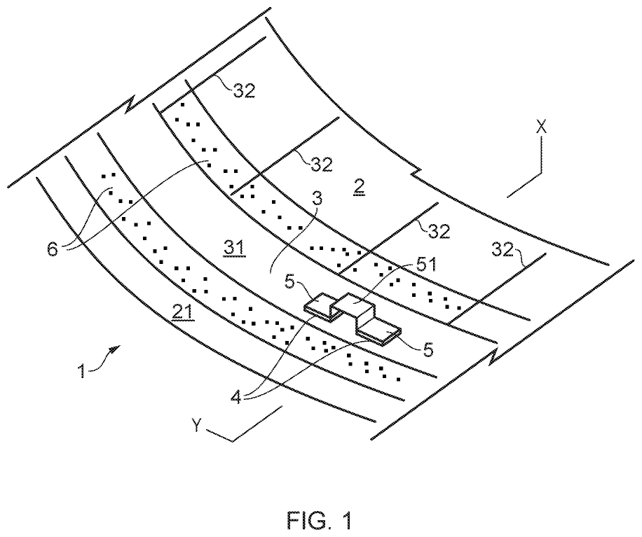

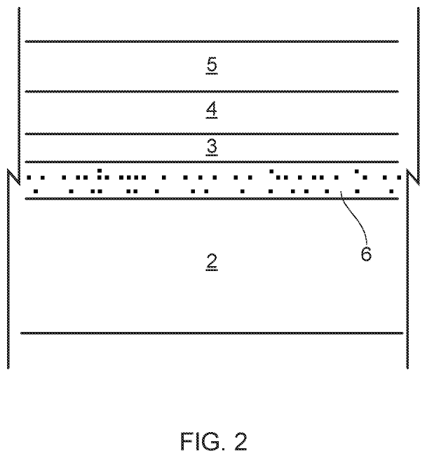

For better understanding of the present invention, the present invention is described using figures. FIG. 1 shows a schematic view of the main parts of a vehicle window glass embodying the present invention. FIG. 2 shows the X-Y cross-section of FIG. 1. In accordance with typical embodiments of the present invention, a vehicle window glass 1 comprises a glass substrate layer 2 having an edge portion 21, an optional colored ceramic band layer 6 sintered on a peripheral portion of the glass substrate layer 2, an electrically conductive layer 3, sintered on the glass substrate layer 2 and/or on the colored ceramic band layer 6 and having a pair of busbars 31 and plural conductive wires 32 connected to the busbars 31, a lead-free solder layer 4 on the conductive layer 3 (preferably on a busbar 31 thereof), and a metal plate element 5 on the solder layer 4, to be connected to electric wiring either directly or via a metal bridge portion 51 connecting two such metal plate elements 5. The metal plate element constitutes or is comprised in an electrical connector. The connector may be made or formed from metal plate material, especially in a single piece. The connector may comprise one or at least one metal plate element 5, or may comprise two metal plate elements 5 and a metal bridge 51 connecting the two metal plate elements 5. A metal plate element 5 lies against the solder layer 4.

The glass substrate layer 2 preferably has a curved shape, obtainable e.g. by a known bending process of a flat glass sheet. The glass substrate layer 2 may be a thermally tempered glass, a chemically tempered glass or a laminated glass. As a material of the glass substrate layer 2, a soda-lime silicate glass defined by 1SO16293-1 can be used. The soda-lime silicate glass may comprise a colorant such as iron oxide and cobalt oxide, whereby to present a color such as pale green, dark green, pale gray, dark gray, pale blue or dark blue.

The colored ceramic band layer 6 is of a color ceramic composition preferably comprising an inorganic heat-resisting pigment and a glass frit that has lower softening temperature than that of the glass substrate layer 2. Such a peripheral band layer is well-known, and sometimes called a frit layer, ceramic band or paint band. The colored ceramic band layer 6 is used to overlie an adhesion area between the vehicle window glass 1 and a body flange of a vehicle. It can improve weather resistance of the adhesion area and/or make it invisible by covering it, so that black color is preferable as the hue of the colored ceramic band layer 6. The thickness of the colored ceramic band may be e.g. 5 μm to 25 μm, preferably 5μm to 15μm.

The colored ceramic band layer 6 can be obtained through the following process, for example. That is, a ceramic paste comprising the inorganic heat-resisting pigment, a glass frit and organic solvent is applied on the peripheral portion of the glass substrate layer 2 by a screen printing method or the like, and then heated, volatilizing the organic solvent. Subsequently, the composition comprising the inorganic heat-resisting pigment and glass frit is sintered on the glass substrate layer thereby forming the colored ceramic band layer 6.

The inorganic heat-resisting pigment is mixed to the color ceramic to give a desired color. The grain diameter of the inorganic heat-resisting pigment may be e.g. 0.1 μm to 10 μm, preferably 0.2 μm to 5 μm, in median diameter (D50). As the inorganic heat-resisting pigment, usual ones can be used. As examples of black pigments, there can be mentioned copper-chromium complex oxide, iron-manganese complex oxide, cobalt-iron-manganese complex oxide, copper-chromium-manganese complex oxide, magnetite and the like.

As examples of blue pigment, there can be mentioned cobalt blue, chromium green, cobalt-zinc-nickel-titanium complex oxide, cobalt-aluminum-chromium complex oxide and the like.

In addition to the above-mentioned, there can be used white pigment (e.g. titanium white, zinc oxide and the like), red pigment (e.g. rouge and the like), yellow pigment (e.g. titanium yellow, titanium-barium-nickel complex oxide, titanium-antimony-nickel complex oxide, titanium-antimony-chromium complex oxide and the like) and other pigments in line with the skilled person's knowledge.

The glass frit is fused through a heating process to form the colored ceramic band layer 6. As the glass frit, usual ones can be used. As an example of the glass frit, there can be mentioned borosilicate glass, boron-zinc-silicate glass, bismuth-based glass and the like. A softening temperature of the glass frit may be a lower temperature, for example 300-600° C., preferably 350-580° C., than a bending and forming temperature of the glass substrate 2. The grain diameter of the glass frit may be 0.1 μm to 10 μm, preferably 0.2 μm to 5 μm, further preferably 1 μm to 4 μm (determined as DS0). In the colored ceramic band 6, the content of the glass material made of the glass frit may be 60 mass % to 80 mass %.

The colored ceramic band layer 6 can be also obtained through other methods besides the above-mentioned process. As an example of such other processes, there can be mentioned a digital printing process.

The electrically conductive layer 3, preferably sintered on the glass substrate layer 2 and/or on the colored ceramic band layer 6, has a pair of busbars 31 and plural conductive wires 32 connected to the busbars 31. The electrically conductive layer 3 preferably comprises silver metal (silver or silver alloy) and a glass frit which may be selected form those exemplified above. The thickness of the electrically conductive layer 3 may be e.g. 3 μm to 20 μm, preferably 5 μm to 15 μm, more preferably 12 μm to 17 μm.

The electrically conductive layer 3 can be obtained through the following process. That is, a silver paste comprising the silver metal, the glass frit and an organic solvent is applied on the glass substrate layer 2, or on the coated and dried ceramic color layer, by screen printing method or the like, and then is heated, volatilizing the organic solvent. Subsequently, the composition comprising the silver metal and the glass frit is sintered on the glass substrate layer 2 or colored ceramic band 6 thereby forming the electrically conductive layer 3. As is well-known, the electrically conductive layer 3 can be used as a printed hot-wire such as a defogger and defroster, or as an antenna.

The grain diameter of the silver metal may be e.g. 0.1 μm to 10 μm, preferably 0.2 μm to 7 μm (determined as D50). In the electrically conductive layer 3, the content of the silver metal may be e.g. 65 mass % to 99 mass %, preferably 75 mass % to 98 mass %.

The electrically conductive layer 3 can be also obtained through other methods besides the above-mentioned process. As an example of such other processes, there can be mentioned a digital printing process.

The lead-free solder layer 4 made of a soldered lead-free solder connects the electrically conductive layer 3 with the metal plate elements 5 of the electrical connector. The lead-free solder may comprise tin and silver. As an example of such lead-free solder, there can be mentioned Sn-Ag based solder, Sn-Ag-Cu based solder and the like. The content of Sn may be e.g. 95 mass % to 99 mass %, preferably 96 mass % to 98 mass %. The content of Ag may be e.g. 1 mass % to 5 mass %, preferably 2 mass % to 4 mass %. The content of Cu may be e.g. 0 mass % to 1.5 mass %, preferably 0.1 mass % to 1 mass %.

The thickness of the lead-free solder layer 4 is desirably between 0.1 mm and 0.3 mm. In the case that the thickness is more than 0.3 mm, a difference of thermal expansion behavior between the glass substrate 2 and the solder layer 4 may cause mechanical stress at an interface of the glass substrate layer 2 or the electrically conductive layer 3 during the soldering process, or while using the window glass 1 fitted in a vehicle. The mechanical stress may enhance a risk of permanent tensile stress in the glass substrate layer 2, resulting in crack generation in the glass substrate layer 2. On the other hand, in the case that the thickness is less than 0.1 mm, it may enhance a risk of a generation of hot spots at the solder layer during the soldering process. The generation of hot spots may result in the residual stress in the glass substrate 2, which causes cracking in the glass substrate 2.

Considering all the factors, the thickness of the lead-free solder layer 4 may be preferably between 0.15 mm and 0.25 mm.

The metal plate element 5 on the solder layer 4 is to be directly connected to an electric wiring or to be connected the electric wiring via metal bridge 51. The thickness of the metal plate element 5 on the solder layer 4 can influence the mechanical stress between the glass substrate 1 and the metal plate element 5. WO2007/110610 suggests that the thickness of the metal plate should be as thin as possible to reduce the mechanical stress. In this invention, however, the metal plate element 5 should be 0.5 mm to 0.7 mm thick.

In the case that the thickness is more than 0.7 mm, the mechanical stress can be too big to compensate, resulting in low yield of window glass 1 due to the occurrence of cracks in some window glasses 1. On the other hand, in the case that the thickness is less than 0.5 mm, hot spots easily generate in the connector under soldering process with electric resistance heating of the connector, causing residual stress in the glass substrate layer 2. The residual stress turns into cracks in the glass substrate layer 2.

Further, such a metal plate element 5 (i.e. less than 0.5 mm thick) needs to be very carefully handled to preserve flatness of the surface facing the lead-free solder layer 4 of the terminal, and this difficulty leads to low productivity of the window glass 1. A metal plate element 5 with a less flat surface can cause an inhomogeneous lead-free solder layer 4. The inhomogeneous lead-free solder layer 4 is liable to cause mechanical stress at the glass substrate layer side.

Considering above mentioned factors, the thickness of the metal plate element 5 on the solder layer 4 may be preferably 0.52 mm to 0.65 mm, more preferably 0.54 mm to 0.6 mm. The surface of the metal plate element 5 facing the solder layer 4 may desirably be flat, such as in particular having no protrusions or indentations, and/or not being bent or angled.

A big difference in thermal expansion coefficient between the metal plate element 5 and the glass substrate layer 2 may affect the mechanical stress between the window glass and the electrical connector. From that point of view, the metal plate element 5 preferably has similar thermal expansion coefficient to the glass substrate layer 2.

As an example of such metal plate element 5, there can be mentioned an iron alloy such as ferroaluminum, ferroboron (preferably 12 mass % to 20 mass % of boron, at most 3 mass % of silicon, at most 2 mass % of aluminum, at most 1 mass % of carbon), ferrocerium, ferrochromium, ferromagnesium, ferromanganese, ferromolybdenum, ferroniobium, ferronickel (Invar, Kovar, and the like) and the like. Among them, ferronickel alloy such as Invar (iron-nickel alloy) and Kovar (iron-nickel-cobalt alloy) is preferable.

A thermal expansion coefficient of Invar 48 containing 48 mass % of nickel is roughly 9×10⁻⁶/degree C., which value is very close to one of a soda-lime silicate glass defined by 1SO16293-1. Therefore, Invar 48 is the most preferable as a material of metal plate element 5.

The electrical connector comprises at least one metal plate element 5, and may comprise two metal plate elements 5 and a metal bridge 51 connecting the two metal plate elements 5 as shown in FIG. 1. The metal plate element 5 that is soldered to the conductive layer and the metal bridge 51 are preferably made from one metal material, preferably formed through processing one flat plate metal piece. Further, the metal plate element 5 may be a part of a crimped-wire antenna. In such case, it goes without saying that metal plate element 5 plays a role as an electrical connector.

The metal plate element 5 may be coated with at least one metal selected from a group consisting of Ni, Cu and Ag. Such coated metal plate element can improve wettability between the metal plate element 5 and melted lead-free solder. Further, the metal plate element 5 may be coated with a first Ni layer of 2 μm-5 μm thickness on the metal plate element 5, an intermediate Cu layer of 2 μm-5 μm thickness on the first Ni layer, and an external Ag layer of 5 μm-8 μm thickness on the Cu layer. The external Ag layer can promote the wettability and adhesion of the solder to the metal plate element. The intermediate Cu layer can protect a galvanic corrosion resulting from difference of ionization tendency between the Ag layer and “the first Ni layer or the metal plate element” and improve the electrical conductivity of Iron-based metal plate element 5. The first Ni layer may play a role as a primer to coating of the intermediate Cu layer. Not only the metal plate element 5 but also metal bridge 51 may be coated with same coating material(s) of the metal plate element 5.

A producing method of the window glass 1 may comprise:
a step of preparing the glass substrate layer 2 having the electrically conductive layer 3 over the glass substrate 2 and optional colored ceramic band layer 6 between the glass substrate layer 2 and the conductive layer 3;
a step of preparing the electrical connector comprising at least one metal plate element 5 whose surface is welded by lead-free solder;
a step of placing the lead-free solder on the conductive layer 3, and a step of energizing to heat the electrical connector to melt the lead-free solder—this step corresponds to a soldering process with electric resistance heating.

### Experimental

### Example

A base test specimen was prepared. The specimen comprises a thermally tempered glass substrate layer 2 of 3 mm thickness and made of a soda-lime silicate glass defined by ISO16293-1, and an electrically conductive layer 3 comprising a busbar 31 fired from silver paste on the glass substrate layer 2. An electrical connector was also prepared, comprising two rectangular metal plate elements 5 (each having 6×4 mm² area), on each of which one side is welded to 45 mg to 50 mg of lead-free solder made of Sn(96.5 mass %)-Ag (3.0 mass %)-Cu (0.5 mass %), and with a metal bridge 51 connecting the two metal plate elements 5. The electrical connector was processed from a flat plate metal of 0.55 mm thickness made of Invar 48 coated with a first Ni layer on the metal, an intermediate Cu layer on the first Ni layer, and an external Ag layer on the intermediate Cu layer.

The lead-free solder on the electrical connector was placed on the busbar 31 of the base test specimen, and heated by energizing between the two metal plate elements 5. By this step the lead-free solder was melted, and the electrical connector and the busbar 31 were soldered by the lead-free solder. In this experiment the soldered specimen was taken as the vehicle window glass 1.

The following heat cycle tests were conducted for ten samples made in accordance with Example 1.
(1) 20 times repeat of alternate cycling from −40° C. to +80° C. over 12 hours.
(2) Holding each sample at −40° C. for 4 hours and at +80° C. for 4 hours, with 80% controlled humidity at positive temperatures and uncontrolled humidity at negative temperatures.

No crack in the glass substrate 2 was observed for any of the ten samples.

### Comparative Example 1

The procedure of Example 1 was repeated with the exception that the electrical connector was processed from a flat plate metal of 0.4 mm thickness. Cracking was observed for 3 out of the 10 samples in this comparative example.

### Comparative Example 2

The procedure of Example 1 was repeated with the exception that the electrical connector was processed from a flat plate metal of 0.8 mm thickness. Cracking was observed for 3 out of the 10 samples in this comparative example.

1. A vehicle window glass, comprising:
a glass substrate;
an electrically conductive layer forming a conductive pattern over the glass substrate;
a lead-free solder layer on the conductive layer; and
a metal plate element on the solder layer, the thickness of the metal plate element being between 0.5 mm and 0.7 mm.
